(19) United States
(12) Patent Application Publication
(10) Pub. No.: US 2025/0362446 A1
(43) Pub. Date: Nov. 27, 2025

(54) Ultra-wideband gain-active optical fiber in S+C+L bands

(71) Applicant: Shanghai University, Shanghai (CN)

(72) Inventors: Tingyun WANG, Shanghai (CN); Yanhua Dong, Shanghai (CN); Jianxiang Wen, Shanghai (CN); Hongyu Liu, Shanghai (CN)

(21) Appl. No.: 19/292,270

(22) Filed: Aug. 6, 2025

Related U.S. Application Data
(63) Continuation of application No. PCT/CN2025/076625, filed on Jan. 2, 2025.

(30) Foreign Application Priority Data
Dec. 14, 2023 (CN) 202311726561.5

(51) Int. Cl. G02B 6/02

(52) U.S. Cl. CPC G02B 6/02338; G02B 6/02357; G02B 6/02361; G02B 2207/107

(57) ABSTRACT

The present disclosure discloses an S+C+L band ultra-wideband gain-active optical fiber, including sequentially from the inner to outer layers: an inner core layer, an inner cladding layer, a core layer, a porous layer, and a cladding layer. The inner core layer is doped with Tm ions, the inner cladding layer is doped with F elements, the core layer is doped with Er ions, and the porous layer is doped with Bi, Al, and P ions. In the fiber structure, the Tm ions in the inner core layer are completely enveloped by the inner cladding layer formed by F elements, placing the Tm ions in a low phonon energy environment provided by the F elements, thereby enhancing their luminescence efficiency in the S-band.

### CROSS-REFERENCE TO RELATED APPLICATIONS

This application is a bypass continuation application of PCT/CN2025/076625. This claims priorities from PCT application PCT/CN2025/076625, filed Feb. 10, 2025, and from Chinese patent application 202311726561.5 filed Dec. 14, 2023, the content of which is incorporated herein in the entirety by reference.

### TECHNICAL FIELD

This disclosure pertains to the field of optical fiber communication and fiber optic technology, specifically involving an optical fiber core structure co-doped with Erbium, Thulium, Bismuth, and Fluorine.

### BACKGROUND

In recent years, with the increasing data transmission in optical communication systems and continuous advancements in fiber optic technology, DWDM technology has matured significantly, placing greater demands on optical amplification techniques within communication wavelength bands. The traditional C-band bandwidth range is no longer sufficient to meet the needs of communication systems, leading to exploration of optical amplification within the S-band and L-band ranges to support higher-capacity optical communication systems. Therefore, developing ultra-wideband active amplification fibers covering the S+C+L bands could effectively expand the capacity of communication systems.

In 2015, Chinese Patent 201510941655.3 proposed the use of Atomic Layer Deposition (ALD) technology to alternately deposit Bi and Er ions or Bi, Er, and Al ions to prepare a controllable concentration co-doped silica optical fiber. This fiber enables ultra-wideband amplification in the C+L bands. In 2018, Chinese Patent 201711327868.2 introduced a fiber amplifier using Thulium and Erbium co-doped bismuthate glass to achieve broadband amplification in the S-band. In 2020, Chinese Patent 202010073619.0 suggested using an improved Modified Chemical Vapor Deposition (MCVD) and other processes to prepare Bi/Er/La/Al co-doped silica optical fiber, capable of ultra-wideband emission in the L-band or C+L bands. In 2020, Chinese Patent 202010551558.4 proposed a method combining solution and MCVD processes to prepare broadband gain Erbium-doped fibers, exhibiting ultra-wideband high-gain characteristics in the 1510˜1580nm range. In 2021, Chinese Patent 201911335359.3 presented a method for preparing Er/Yb/P co-doped glass rods based on nanoporous technology to extend the Er ion emission bandwidth to the S-band, achieving broadband emission in the S and C bands. Most of the aforementioned patents focus on broadband amplification in the C+L or S+C bands and do not achieve ultra-wideband amplification in the S+C+L bands. This is because doping Tm ions in the S-band requires a low phonon energy environment for optimal emission characteristics, which silica matrices cannot provide. Additionally, co-doping Tm ions with Er ions inevitably results in energy transfer from Er ions to Tm ions, reducing the emission efficiency of Er ions in the C+L bands and narrowing the bandwidth of the C+L bands.

### SUMMARY

The technical problem addressed by the present disclosure: To address the shortcomings of the existing technologies mentioned above, this disclosure resolves the issues of Tm ions' requirement for a low phonon energy environment and the avoidance of energy transfer between Er ions and Tm ions. By designing a multi-layered fiber structure, the disclosure utilizes an inner thin layer containing Fluorine elements to provide a low phonon energy environment for Tm ions, while also preventing energy transfer from Er ions to Tm ions. This approach aims to enhance the emission efficiency of Er ions and Tm ions, achieving ultra-wideband gain in the S+C+L bands.

### Technical Solution of the Disclosure

The gain-active optical fiber for ultra-wideband in the S+C+L bands, consisting of layers from the inside out including an inner core layer, an inner cladding layer, a core layer, a porous layer, and a cladding layer. The inner core layer is doped with Tm ions, the inner cladding layer with F elements, the core layer with Er ions, and the porous layer with Bi, Al, and P ions.

The optical fiber fabrication method sequentially deposits doping elements into a silica-based tube to form the inner core layer, inner cladding layer, core layer, porous layer, and outer cladding structure. Tm ions emit light in the S-band, while Er ions emit in the C+L bands. The co-doping of these two rare earth elements ensures emission peaks overlap, enabling broadband emission in the S+C+L bands. Within the fiber structure, the Tm ions in the inner core layer are completely surrounded by the inner cladding layer doped with F elements, placing Tm ions in a low phonon energy environment provided by F elements, thereby enhancing their emission efficiency in the S-band. The core layer is encapsulated by the porous layer and inner cladding layer, preventing direct contact between Er ions in the core layer and Tm ions in the inner core layer, reducing the probability of energy transfer, minimizing mutual interference between Tm and Er ions, and improving the emission efficiency of Er and Tm ions in the S, C, and L bands.

The doping concentration ranges are as follows: Er ions doping controlled within 0.01 to 4 mol %; Tm ions doping controlled within 0.01 to 2 mol %; Bi ions doping controlled within 0.01 to 1.5 mol %; F ions doping controlled within 0.01 to 1 mol %; Al ions doping controlled within 0.01 to 10 mol %; P ions doping controlled within 0.01 to 10 mol %.

The optical fiber structure consists of a core and cladding. The core includes an inner core layer, inner cladding layer, core layer, and porous layer. The core diameter ranges from 4 to 25 μm, and the cladding diameter ranges from 70 to 250 μm. The refractive index difference between the core and cladding ranges from 0.002 to 0.05.

The absorption wavelength range of the optical fiber is 450-1625 nm; the luminescence wavelength range is 1260-1650 nm; the wavelength range with gain greater than 20 dB is 1460-1625 nm, and the noise FIG. is consistently below 5 dB. This achieves ultra-wideband gain in the S+C+L bands.

### The Beneficial Effects of the Present Disclosure

The preparation of S+C+L band ultra-wideband gain-active optical fibers doped with Er/Tm/Bi/F co-doped elements and a special fiber structure effectively enhances the luminescence efficiency of rare earth ions in the corresponding bands. By improving the fiber structure, F elements deposited in the inner cladding encapsulate Tm ions in the core layer, placing Tm ions in an environment of very low phonon energy, thereby ensuring efficient luminescence in the S-band. Moreover, reducing the energy transfer probability between Er ions and Tm ions minimizes the impact of Tm ions on the C+L bands luminescence bandwidth of Er ions. The superposition of luminescence bands from Tm and Er ions enables the optical fiber to achieve ultra-wideband amplification across the S+C+L bands.
1. The prepared S+C+L band ultra-wideband gain-active optical fibers exhibit low background loss and high absorption intensity, characterized by high gain and low noise FIG. in the S+C+L bands.
2. The fiber fabrication process is simple and cost-effective, suitable for wide application in optical amplifiers, broadband light sources, fiber lasers, tunable lasers, and other fiber optic communication devices

### BRIEF DESCRIPTION OF THE DRAWINGS

FIG. 1 is a schematic diagram illustrating the structure of the optical fiber of the present disclosure. In the diagram, (1) represents the inner core layer, (2) represents the inner cladding layer, (3) represents the core layer, (4) represents the porous layer, and (5) represents the cladding layer.

FIG. 2 depicts the gain characteristic of the optical fiber prepared according to the present disclosure.

### DETAILED DESCRIPTION

The following detailed description of the disclosure is provided with reference to the accompanying drawings and specific embodiments.

### Embodiment 1

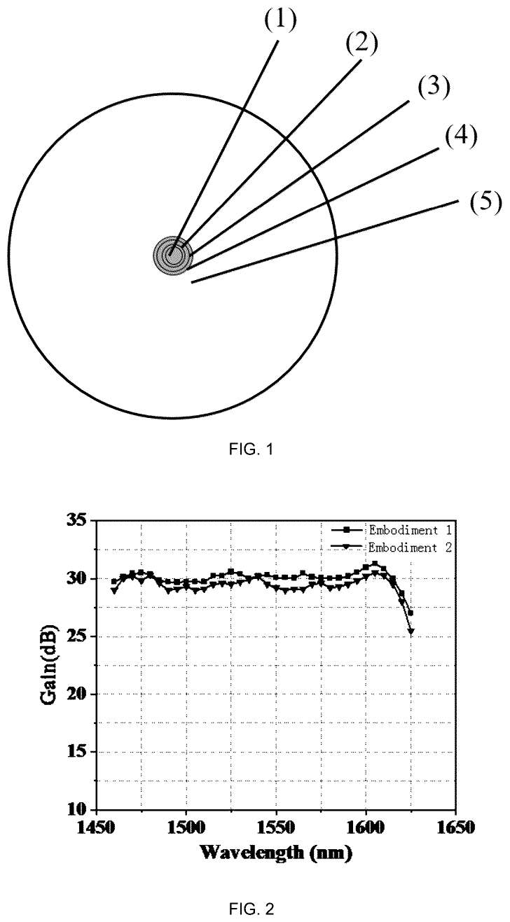

Referring to FIG. 1, an S+C+L band ultra-wideband gain-active optical fiber is prepared using high-temperature chemical vapor deposition. Bi, Al, and P ions are introduced into the inner wall of a silica tube previously deposited with SiO₂ to form a porous layer. Subsequently, a large amount of Er ions are introduced into the silica tube to deposit on the porous layer as the core layer. Fluorine (F) ions are then introduced to cover the core layer as the inner cladding layer. Tm ions are introduced to form the inner core layer. Finally, a high-temperature shrink rod process is employed, followed by drawing to form the fiber. The core diameter of the prepared fiber is 9.1 μm, and the cladding diameter is 126.1 μm. The doping concentrations are as follows: Er ion concentration is 0.4 mol %, Tm ion concentration is 0.2 mol %, Bi ion concentration is 0.1 mol %, F ion concentration is 0.05 mol %, Al ion concentration is 0.5 mol %, and P ion concentration is 1 mol %.

Referring to FIG. 2, the gain characteristic for Embodiment 1 of the S+C+L band ultra-wideband gain-active optical fiber demonstrates its capability for broad amplification across the S+C+L bands.

### Embodiment 2

Referring to FIG. 1, an S+C+L band ultra-wideband gain-active optical fiber is prepared using high-temperature chemical vapor deposition. Bi and Al ions are introduced into the inner wall of a silica tube previously deposited with SiO₂ to form a porous layer. Subsequently, a large amount of Er ions are introduced into the silica tube to deposit on the porous layer as the core layer. Fluorine (F) ions are then introduced to cover the core layer as the inner cladding layer. Tm ions are introduced to form the inner core layer. Finally, a high-temperature shrink rod process is employed, followed by drawing to form the fiber. The core diameter of the prepared fiber is 8.9 μm, and the cladding diameter is 125.4 μm. The doping concentrations are as follows: Er ion concentration is 0.4 mol %, Tm ion concentration is 0.2 mol %, Bi ion concentration is 0.1 mol %, F ion concentration is 0.05 mol %, and Al ion concentration is 0.5 mol %.

Referring to FIG. 2, the gain characteristic for Embodiment 2 of the S+C+L band ultra-wideband gain-active optical fiber demonstrates its capability for broad amplification across the S+C+L bands.

1. A ultra-wideband gain-active optical fiber in the S+C+L bands, comprises the following structure from the inside out: the fiber sequentially includes an inner core layer, an inner cladding layer, a core layer, a porous layer, and a cladding layer. The inner core layer is doped with Tm ions, the inner cladding layer is doped with F elements, and the core layer is doped with Er ions.

2. The ultra-wideband gain-active optical fiber in the S+C+L bands, as described in claim 1, wherein the presence of Bi, Al, and P ions doped into the porous layer.

3. The gain-active optical fiber for ultra-wideband in the S+C+L bands, as described in claim 2, comprises: Er ions doping concentration controlled within the range of 0.01 to 4 mol %; Tm ions doping concentration controlled within the range of 0.01 to 2 mol %; Bi ions doping concentration controlled within the range of 0.01 to 1.5 mol %; F ions doping concentration controlled within the range of 0.01 to 1 mol %; Al ions doping concentration controlled within the range of 0.01 to 10 mol %; P ions doping concentration controlled within the range of 0.01 to 10 mol %.

4. The gain-active optical fiber for ultra-wideband in the S+C+L bands, as described in claim 2, comprises: inner core layer, inner cladding layer, core layer, and porous layer forming the core of the fiber, with a core diameter of 4 to 25 μm, and a cladding diameter of 70 to 250 μm.

5. The gain-active optical fiber for ultra-wideband in the S+C+L bands, as described in claim 4, comprises: refractive index difference between core and cladding in the range of 0.002 to 0.05.

6. The gain-active optical fiber for ultra-wideband in the S+C+L bands, as described in claim 3, comprises: the absorption wavelength range of the optical fiber is 450˜1625 nm; the emission wavelength range is 1260˜1650 nm; the wavelength range with gain greater than 20 dB is 1460˜1625 nm, and noise figure consistently below 5 dB.

7. The gain-active optical fiber for ultra-wideband in the S+C+L bands, as described in claim 4, comprises: the absorption wavelength range of the optical fiber is 450˜1625 nm; the emission wavelength range is 1260˜1650 nm; the wavelength range with gain greater than 20 dB is 1460˜1625 nm, and noise figure consistently below 5 dB.

8. The gain-active optical fiber for ultra-wideband in the S+C+L bands, as described in 5, comprises: the absorption wavelength range of the optical fiber is 450˜1625 nm; the emission wavelength range is 1260˜1650 nm; the wavelength range with gain greater than 20 dB is 1460˜1625 nm, and noise figure consistently below 5 dB.
